(19) United States
(12) Patent Application Publication
(10) Pub. No.: US 2022/0246971 A1
(43) Pub. Date: Aug. 4, 2022

(54) DEVICE FOR GROUPING TOGETHER FUEL CELLS, COMPRISING A SUPPORT CONFIGURED TO SUPPLY THE FUEL CELLS WITH FLUID, AND AIRCRAFT COMPRISING AT LEAST ONE SUCH FUEL CELL GROUPING DEVICE

(71) Applicant: Airbus Operations SAS, TOULOUSE (FR)

(72) Inventors: Janik FERNANDEZ GARCIA, TOULOUSE (FR); Jordan COOK, TOULOUSE (FR); Julien CAYSSIALS, TOULOUSE (FR); Christophe LABARTHE, TOULOUSE (FR)

(21) Appl. No.: 17/584,858

(22) Filed: Jan. 26, 2022

(30) Foreign Application Priority Data
Jan. 29, 2021 (FR) 2100905

(51) Int. Cl. H01M 8/2483; H01M 8/2404; B64D 27/24; H01M 8/2475

(52) U.S. Cl. CPC H01M 8/2483; H01M 8/2475; B64D 27/24; H01M 8/2404

(57) ABSTRACT

A device for grouping together fuel cells, including at least two fuel cells, a support including a casing, at least one feeder configured to supply the fuel cells with fluid, at least one manifold configured to collect a fluid from the fuel cells, the feeder and the manifold being rigidly secured to the casing and positioned between the casing and the fuel cells.

### CROSS-REFERENCES TO RELATED APPLICATIONS

This application claims the benefit of the French patent application No. 2100905 filed on Jan. 29, 2021, the entire disclosures of which are incorporated herein by way of reference.

### FIELD OF THE INVENTION

The present application relates to a grouping device for grouping together fuel cells comprising a support configured to supply the fuel cells with fluid and to an aircraft comprising at least such a device for grouping together fuel cells.

### BACKGROUND OF THE INVENTION

A fuel cell is a device that generates an electric voltage by virtue of oxidation on an electrode of a reduction fuel, such as hydrogen for example, together with reduction on another electrode of an oxidant, such as oxygen from the air, for example.

According to one embodiment shown in FIG. 1, a fuel cell 10 comprises a first inlet and outlet 12.1, 12.2 for a first fluid, in particular the fuel, a second inlet and outlet 14.1, 14.2 for a second fluid, in particular the oxidant, and a third inlet and outlet 16.1, 16.2 for a third fluid, in particular, a coolant.

According to one configuration, the first inlet and outlet 12.1, 12.2 intended for the first fluid are connected to a first circuit 12 which comprises a supply of first fluid 20.1 and various apparatus such as a first water extraction system 20.2, a recirculation pump 20.3, a first flow management system 20.4 and a drainage system 20.5, for example.

The second inlet and outlet 14.1, 14.2, intended for the second fluid, are connected to a second circuit 14 which comprises a supply of second fluid 22.1 and various apparatus such as a dehumidification system 22.2, a second flow management system 22.3 and a second water extraction system 22.4, for example.

The third inlet and outlet 16.1, 16.2, intended for the third fluid, are connected to a third circuit 16 which comprises a heat exchanger 24.1 configured to regulate the temperature of the third fluid.

In the case of an aircraft, several fuel cells 10 are needed. The many fuel cells 10, fluid circuits and associated apparatus increases the number of points of attachment on the primary structure of the aircraft, the space required to house all of these elements, the number of connections, and hence the risk of leaks.

The present invention aims to overcome all or some of the drawbacks of the prior art.

### SUMMARY OF THE INVENTION

To this end, the subject matter of the invention is a grouping device for grouping together fuel cells comprising at least two fuel cells in which at least a first fluid flows, characterized in that the grouping device comprises a support and at least a portion of a first circuit for the first fluid comprising a first feeder configured to supply the fuel cells with first fluid and a first manifold configured to collect the first fluid from the fuel cells, the support comprising a casing, the first feeder and the first manifold being rigidly secured to the casing and positioned between the casing and the fuel cells.

Such a grouping device may be moved or handled in one piece. It also makes it possible to limit the number of points of attachment on the primary structure of an aircraft. Positioning the first feeder and the first manifold between the casing and the fuel cells makes it possible to obtain a more compact assembly.

According to another feature, each casing comprises at least one outer shoulder extending over at least part of its periphery.

Thus, on account of having a one-piece grouping device, the shoulder makes it possible to transfer the loads from the assembly to the structure on which the shoulder is made to rest and, as will be seen below, in particular the primary structure of an aircraft.

According to one feature, the shoulder extends over the whole periphery of the device.

According to another feature, the grouping device comprises:
at least a second portion of a second circuit for a second fluid flowing in the fuel cells comprising a second feeder configured to supply the fuel cells with second fluid and a second manifold configured to collect the second fluid from the fuel cells,
at least a third portion of a third circuit for a third fluid flowing in the fuel cells comprising a third feeder configured to supply the fuel cells with third fluid and a third manifold configured to collect the third fluid from the fuel cells,
the second and third feeders being rigidly secured to the casing, at least one of them being positioned between the casing and the fuel cells, the second and third manifolds being rigidly secured to the casing, at least one of them being positioned between the casing and the fuel cells.

According to another feature, the casing comprises at least one opening configured to interact with at least one of the fuel cells, through which opening ducts connected to the fuel cell pass.

According to another feature, the casing comprises a bottom, two transverse walls and two longitudinal walls which delimit a housing configured to house at least one feeder out of the first, second and third feeders and at least one manifold out of the first, second and third manifolds.

According to another feature, the transverse and longitudinal walls comprise upper edges forming a belt which, in operation, surrounds the fuel cells.

According to another feature, the casing comprises at least an inner shoulder offset towards the bottom relative to the upper edges of the transverse and longitudinal walls, said inner shoulder constituting a contact surface for the fuel cells.

According to another feature, for each first, second or third feeder or manifold positioned between the casing and the fuel cells, the casing comprises a first or second through hole configured to house a supply or discharge duct of the feeder or of the manifold or a duct extending the supply or discharge duct of the feeder or of the manifold.

According to another feature, for each first, second or third feeder or manifold positioned on the outside of the casing, the casing comprises a third or fourth through hole for each outlet or inlet duct of the feeder or of the manifold, each third or fourth through hole being configured to house one of the outlet or inlet ducts of the feeder or of the manifold or a duct extending one of the outlet or inlet ducts of the feeder or of the manifold.

According to another feature, the grouping device comprises at least one apparatus for at least one fluid circuit comprising first and second parts removably connected by connection elements, at least one of the first and second parts being rigidly secured to and integrated in the casing.

As the grouping device may be moved or handled in one piece, it is thus possible to work quickly and easily on a removable part in which there are provided for example elements which require more regular or more complex maintenance.

According to another feature, the removable part is an active part.

According to another feature, the apparatus is a valve and the removable part comprises the controller for the flow of fluid between an upstream and a downstream part in the part integrated in the casing.

According to another feature, an apparatus is a water extraction system, and the active part comprises a valve for purging the water created by the extraction system.

The subject matter of the invention is also an aircraft comprising a primary structure and at least one fuel cell grouping device according to one of the above features.

According to another feature, the aircraft comprises at least one frame connected to the primary structure of the aircraft for each grouping device, the frame comprising a surround configured to allow insertion of the fuel cells of the grouping device, against which surround the casing bears.

According to another feature, each casing comprises at least one outer shoulder extending over at least part of its periphery and configured to bear against one of the surrounds of the frame in order to transfer the loads from the casing to the primary structure.

According to another feature, a peripheral seal is inserted between the outer shoulder of the casing and the surround of the frame.

### BRIEF DESCRIPTION OF THE DRAWINGS

Further features and advantages will emerge from the description of the invention set out below, this description being provided solely as an example, with reference to the attached drawings, in which:

FIG. 1 schematically shows a fuel cell and its various fluid circuits, illustrating an embodiment of the prior art,

FIG. 2 schematically shows a fuel cell grouping device, illustrating an embodiment of the invention,

FIG. 3 is a perspective view of a fuel cell grouping device, illustrating an embodiment of the invention in the assembled state,

FIG. 4 is a perspective view of the fuel cell grouping device shown in FIG. 3, in the dismantled state,

FIG. 5 is a perspective view showing certain parts of FIG. 4 in detail,

FIG. 6 is a perspective view of a support configured to supply the fuel cells with fluid, illustrating an embodiment of the invention,

FIG. 7 is a cross section through a casing of the support shown in FIG. 6,

FIGS. 8a and 8b are side views of a first apparatus of a fluid circuit, independent of (8a) and semi-integrated in (8b) the support shown in FIG. 6,

FIGS. 9a and 9b are side views of a second apparatus of a fluid circuit, independent of (9a) and semi-integrated in (9b) the support shown in FIG. 6,

FIG. 10 is a perspective view of a frame supporting a first fuel cell grouping device, illustrating a first embodiment,

FIG. 11 is a perspective view of the frame shown in FIG. 10 and of a fuel cell grouping device while being assembled,

FIG. 12 is a perspective view of the frame and the devices for grouping together fuel cells shown in FIG. 11, a main feeder and a main manifold while being assembled, and

FIG. 13 is a perspective view of the frame and the devices for grouping together fuel cells shown in FIG. 12, when assembled.

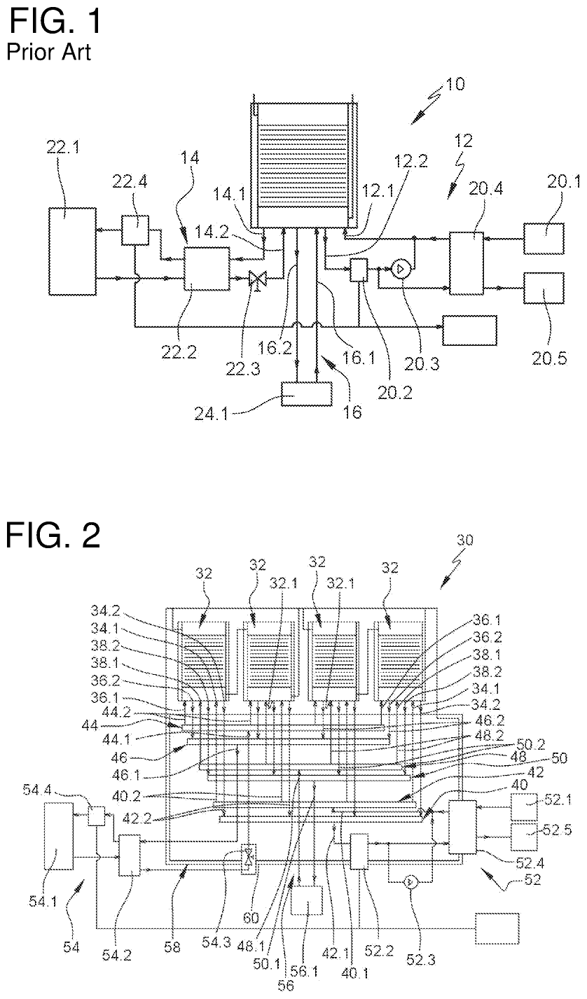

### DETAILED DESCRIPTION OF THE PREFERRED EMBODIMENTS

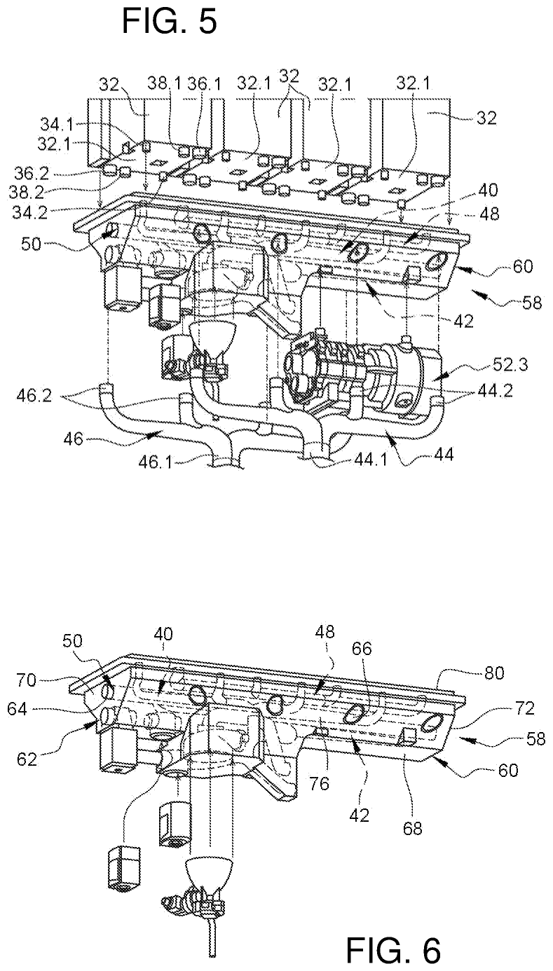

In FIGS. 2 to 5, a grouping device 30 for grouping together fuel cells comprises a plurality of fuel cells 32 each comprising a first inlet and outlet 34.1, 34.2 for a first fluid, in particular a fuel, a second inlet and outlet 36.1, 36.2 for a second fluid, in particular an oxidant, and a third inlet and outlet 38.1, 38.2 for a third fluid, in particular a coolant. According to the embodiments shown in FIGS. 2 to 5, the grouping device 30 comprises four fuel cells 32. As a minimum, the grouping device 30 comprises at least two fuel cells 32. According to one form of use, the first fluid is hydrogen, the second fluid is air, and the third fluid is a coolant liquid.

According to one configuration, each fuel cell 32 has a parallelepiped shape and has a lower face 32.1 on which the various inlets and outlets 34.1, 34.2, 36.1, 36.2, 38.1, 38.2 are positioned.

According to one form of use, an aircraft comprises a primary structure and at least one grouping device 30 connected, directly or indirectly, to the primary structure.

According to one embodiment shown in detail in FIG. 2, the grouping device 30 comprises a first feeder 40, intended for the first fluid, which has a supply duct 40.1 and the same number of outlet ducts 40.2 as the number of first inlets 34.1 of the fuel cells 32 of the grouping device 30. In the case of four fuel cells 32, the first feeder 40 comprises four outlet ducts 40.2. More generally, the first feeder 40 is configured to supply the fuel cells 32 of the grouping device 30 with first fluid.

According to one configuration, this first feeder 40, intended for hydrogen, comprises a reduction in the section for passage, in particular in the outlet ducts 40.2, so as to limit the flow rate of hydrogen in the event of failure of a connection with one of the first inlets 34.1 of the fuel cells 32. This configuration helps improve the safety of the grouping device 30.

The grouping device 30 comprises a first manifold 42, intended for the first fluid, which has a discharge duct 42.1 and the same number of inlet ducts 42.2 as the number of first outlets 34.2 of the fuel cells 32 of the grouping device 30. In the case of four fuel cells 32, the first manifold 42 comprises four inlet ducts 42.2. More generally, the first manifold 42 is configured to collect the first fluid from the fuel cells 32 of the grouping device 30.

According to one configuration, this first manifold 42 intended for hydrogen comprises a reduction in the section for passage, in particular in the inlet ducts 42.2, so as to limit the flow rate of hydrogen in the event of failure of a connection with one of the first outlets 34.2 of the fuel cells 32. This configuration helps improve the safety of the grouping device 30.

The grouping device 30 comprises a second feeder 44, intended for the second fluid, which has a supply duct 44.1 and the same number of outlet ducts 44.2 as the number of second inlets 36.1 of the fuel cells 32 of the grouping device 30. In the case of four fuel cells 32, the second feeder 44 comprises four outlet ducts 44.2. More generally, the second feeder 44 is configured to supply the fuel cells 32 of the grouping device 30 with second fluid.

The grouping device 30 comprises a second manifold 46, intended for the second fluid, which has a discharge duct 46.1 and the same number of inlet ducts 46.2 as the number of second outlets 36.2 of the fuel cells 32 of the grouping device 30. In the case of four fuel cells 32, the second manifold 46 comprises four inlet ducts 46.2. More generally, the second manifold 46 is configured to collect the second fluid from the fuel cells 32 of the grouping device 30.

The grouping device 30 comprises a third feeder 48, intended for the third fluid, which has a supply duct 48.1 and the same number of outlet ducts 48.2 as the number of third inlets 38.1 of the fuel cells 32 of the grouping device 30. In the case of four fuel cells 32, the third feeder 48 comprises four outlet ducts 48.2. More generally, the third feeder 48 is configured to supply the fuel cells 32 of the grouping device 30 with third fluid.

The grouping device 30 comprises a third manifold 50, intended for the third fluid, which has a discharge duct 50.1 and the same number of inlet ducts 50.2 as the number of third outlets 38.2 of the fuel cells 32 of the grouping device 30. In the case of four fuel cells 32, the third manifold 50 comprises four inlet ducts 50.2. More generally, the third manifold 50 is configured to collect the third fluid from the fuel cells 32 of the grouping device 30.

According to a configuration shown in FIG. 2, the grouping device 30 comprises a first fluid circuit 52 comprising the first feeder 40, the first manifold 42, a supply of first fluid 52.1 and various apparatus such as a first water extraction system 52.2, a recirculation pump 52.3, a first flow management system 52.4 and a drainage system 52.5, for example.

According to a first variant, each grouping device 30 has its own supply of first fluid 52.1 and its own drainage system 52.5. According to another variant, a supply of first fluid 52.1 may be common to a plurality of grouping devices 30. Likewise, a drainage system 52.5 may be common to a plurality of grouping devices 30.

According to a configuration shown in FIG. 2, the grouping device 30 comprises a second fluid circuit 54 comprising the second feeder 44, the second manifold 46, a supply of second fluid 54.1 and various apparatus such as a dehumidification system 54.2, a second flow management system 54.3 and a second water extraction system 54.4, for example.

According to a first variant, each grouping device 30 has its own supply of second fluid 54.1 and its own water extraction system 54.4. According to another variant, a supply of second fluid 54.1 may be common to a plurality of grouping devices 30. Likewise, a water extraction system 54.4 may be common to a plurality of grouping devices 30.

According to a configuration shown in FIG. 2, the grouping device 30 comprises a third fluid circuit 56 comprising the third feeder 48, the third manifold 50 and at least one heat exchanger 56.1 configured to regulate the temperature of the third fluid.

According to a first variant, each grouping device 30 comprises its own heat exchanger 56.1. According to a second variant, a heat exchanger 56.1 may be common to a plurality of grouping devices 30.

According to one feature of the invention, the grouping device 30 comprises a support 58, positioned on the lower faces 32.1 of the fuel cells 32 of the grouping device 30, which comprises at least one casing 60, at least one feeder out of the first, second and third feeders 40, 44, 48 positioned between the casing 60 and the fuel cells 32, at least one manifold out of the first, second and third manifolds 42, 46, 50 positioned between the casing 60 and the fuel cells 32.

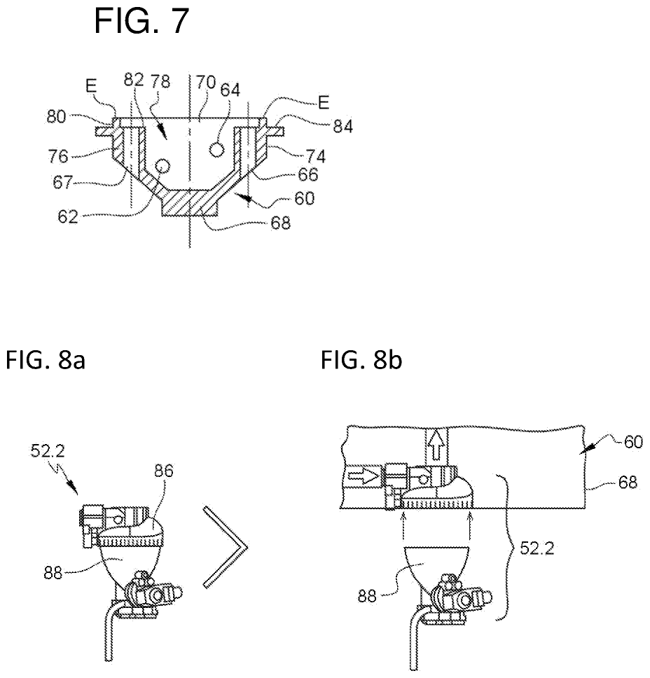

According to a configuration shown in FIG. 7, the casing 60, the first, second and third feeders 40, 44, 48 and the first, second and third manifolds 42, 46, 50 are separate parts. According to another configuration, at least one element out of the first, second and third feeders 40, 44, 48 and the first, second and third manifolds 42, 46, 50 is integrated in the casing 60 and forms a single piece with the casing 60.

The feeder and the manifold for the same fluid are located between the casing 60 and the fuel cells 32 or outside an area between the casing 60 and the fuel cells 32.

According to a first embodiment shown in FIG. 2, the grouping device 30 comprises first, second and third feeders 40, 44, 48 and first, second and third manifolds 42, 46, 50 positioned between the casing 60 and the fuel cells 32.

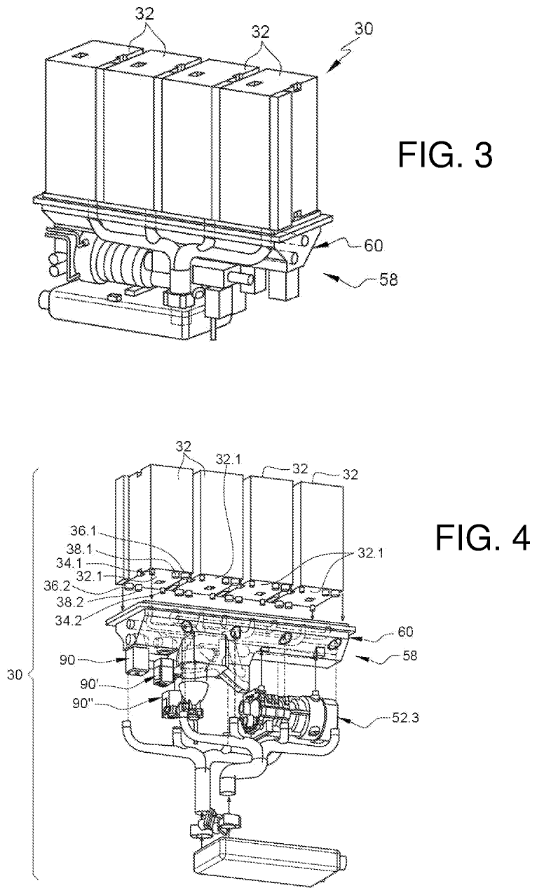

According to a second embodiment shown in FIGS. 3 to 5, the grouping device 30 comprises first and third feeders 40, 48 and first and third manifolds 42, 50 positioned between the casing and the fuel cells 32, the first feeder and the first manifold 40, 42 being intended for the first fluid (hydrogen), the third feeder and the third manifold 48, 50 being intended for the third fluid (coolant).

Each first, second or third feeder 40, 44, 48 and/or each first, second or third manifold 42, 46, 48 positioned between the casing 60 and the fuel cells 32 is supported by the casing 60 and attached to the latter. This arrangement makes it possible to reduce the number of points of attachment on the primary structure of the aircraft.

According to one embodiment, each first, second or third feeder 40, 44, 48 and/or each first, second or third manifold 42, 46, 48 positioned on the outside of the casing 60 is attached to the latter. This arrangement makes it possible to reduce the number of points of attachment on the primary structure of the aircraft.

As shown in FIGS. 6 and 7, for each first, second or third feeder 40, 44, 48 positioned between the casing 60 and the fuel cells 32, the casing 60 comprises a first through hole 62 configured to place the interior and the exterior of the casing in communication and house the supply duct 40.1, 44.1, 48.1 of the feeders 40, 44, 48 or a duct extending the supply duct 40.1, 44.1, 48.1 of the feeder 40, 44, 48.

As shown in FIGS. 6 and 7, for each first, second or third manifold 42, 46, 48 positioned between the casing 60 and the fuel cells 32, the casing 60 comprises a second through hole 64 configured to place the interior and the exterior of the casing 60 in communication and house the discharge duct 42.1, 46.1, 50.1 of the manifold 42, 46, 48 or a duct extending the discharge duct 42.1, 46.1, 50.1 of the manifold 42, 46, 48.

For each first, second or third feeder 40, 44, 48 which is not positioned between the casing 60 and the fuel cells 32, the casing 60 comprises a third through hole 66 for each outlet duct 40.2, 44.2, 48.2 of the feeder 40, 44, 48, as shown in FIGS. 6 and 7, each third through hole 64 being configured to house one of the outlet ducts 40.2, 44.2, 48.2 of the feeder 40, 44, 48 or a duct extending one of the outlet ducts 40.2, 44.2, 48.2 of the feeder 40, 44, 48.

For each first, second or third manifold 42, 46, 48 which is not positioned between the casing 60 and the fuel cells 32, the casing 60 comprises a fourth through hole 67 for each inlet duct 42.2, 46.2, 50.2 of the manifold 42, 46, 48, as shown in FIG. 7, each fourth through hole 67 being configured to house one of the inlet ducts 42.2, 46.2, 50.2 of the manifold 42, 46, 48 or a duct extending one of the inlet ducts 42.2, 46.2, 50.21 of the manifold 42, 46, 48.

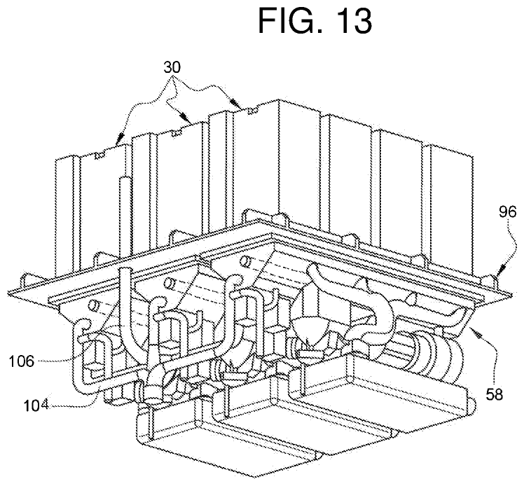

According to one configuration shown, for example, in FIG. 13, the fuel cells 32 are spaced apart slightly in a horizontal plane and aligned in a longitudinal direction, their lower faces 32.1 being substantially coplanar.

According to another configuration, the fuel cells may be positioned one on top of the other and spaced apart slightly in a vertical direction. According to this other configuration, each of the fuel cells comprises a lateral face coplanar with a lateral face of each of the other fuel cells and the support 58 is positioned on these lateral faces.

In the embodiment illustrated, the fuel cells 32 of the grouping device 30 have a rectangular section in a plane parallel to the lower faces 32.1, with a first dimension in the longitudinal direction and a second dimension in a transverse direction perpendicular to the longitudinal direction.

The casing 60 has a bottom 68, two transverse walls 70, 72 and two longitudinal walls 74, 76 which delimit a housing 78, which is substantially sealed, configured to house at least one feeder out of the first, second and third feeders 40, 44, 48 and at least one manifold out of the first, second and third manifolds 42, 46, 50. The housing 78 is partially closed off by the fuel cells 32 when the latter are connected to the casing 60. Naturally, the casing 60 is not limited to this geometry. The casing 60 may have a more or less complex shape which has at least one opening configured to interact with at least one of the fuel cells 32, said opening having the ducts connected to the fuel cell 32 passing through it. The casing 60 may be closed by a panel on its upper face.

The transverse and longitudinal walls 70, 72, 74, 76 have upper edges E forming a belt 80 which, in operation, surrounds the fuel cells 32. This belt 80 is substantially rectangular when seen from above and has a length which is slightly greater than the first dimension and a width which is substantially equal to the second dimension.

According to one embodiment, the casing 60 comprises at least one inner shoulder 82 offset towards the bottom 68 relative to the upper edges E of the transverse and longitudinal walls 70, 72, 74, 76. According to one configuration, the longitudinal walls 74, 76 each comprise an inner shoulder 82. These inner shoulders 82 constitute a contact surface for the lower faces 32.1 of the fuel cells 32. The fuel cells 32 are connected to the casing 60 by appropriate attachment elements.

According to one embodiment, the casing 60 comprises at least one outer shoulder 84 offset towards the bottom 68 relative to the upper edges E of the transverse and longitudinal walls 70, 72, 74, 76. According to one configuration, the outer shoulder 84 extends on the outside of the belt 80, over the whole of its periphery.

According to another feature of the invention, at least one apparatus of the first, second and/or third fluid circuits 52, 54, 56 is positioned on the outside of the casing 60 and connected to the latter by appropriate attachment elements. This is, in particular, the case of the recirculation pump 52.3 of the first fluid circuit 52.

According to one embodiment shown in FIG. 8a, the first water extraction system 52.2 comprises a first upper part 86 comprising at least one segment intended for the first fluid, a lower part 88 comprising at least one flow duct for water and connection elements for removably connecting the first and second parts 86, 88. According to one configuration shown in FIG. 8b, the first part 86 of the first water extraction system 52.2 is rigidly secured to and integrated in the casing 60, in particular the bottom 68 of the casing 60. The second part 88 comprises a valve, in the illustrated case an electric valve, for purging the water when the quantity of water created by the extraction system exceeds a certain level measured by a sensor.

According to one embodiment shown in FIG. 4, the first flow management system 52.4 of the first fluid circuit 52 comprises a plurality of valves 90, 90′, 90″.

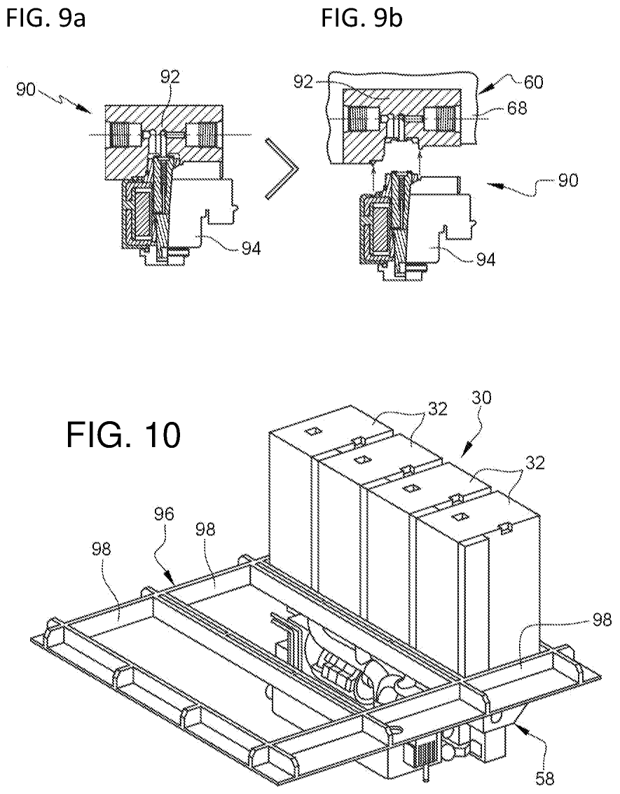

As shown in FIG. 9a, a valve 90 comprises a first part 92 having upstream and downstream segments, a second part 94 comprising a command for controlling a flow of fluid between the upstream and downstream segments and connection elements for removably connecting the first and second parts 92, 94. According to one configuration shown in FIG. 9b, the first part 92 of the valve 90 is rigidly secured to and integrated in the casing 60, in particular the bottom 68 of the casing 60. The first part 92 corresponds to a passive part in which there is no movement of elements, but which has a form allowing the desired flow of the fluids. The part 94 corresponds to the valve and the controller thereof, namely an active part likely to require more significant maintenance.

Thus, according to another feature of the invention, at least one apparatus of the first, second and/or third fluid circuits 52, 54, 56 comprises first and second parts removably interconnected by connection elements, one of the first and second parts being rigidly secured to and integrated in the casing 60. This arrangement helps reduce the number of points of attachment on the primary structure of the aircraft and facilitates maintenance, the apparatus requiring maintenance being positioned in the bottom 68 of the casing 60, partially integrated in this casing 60 and hence accessible from outside the casing 60.

According to one feature of the invention, active parts of the apparatus such as an electric part, a valve or, in the above example, the controller for controlling the flow of fluid are situated in the removable part that is not integrated in the casing so that it can be removed quickly and easily in the event of a fault in order to be repaired or replaced. An active part is a part for actively operating the apparatus in question for example by triggering the power supply for an electric part, by closing, opening a valve or by activating a controller for this purpose or for regulating a flow. It involves moving an element of the apparatus, be this a structural element such as a valve or an electronic element such as a switch for an electronic part. A passive part of an apparatus is, for example, the structural shell in which a fluid can flow or an electric wire in which a current circulates, the shell or the electric wire remaining such that nothing moves. The idea is to provide at least one active part in its entirety or partially in the removable part in order to separate it easily from the casing. If the active part is located partially in the removable part, the components located in the active part are those that require more frequent work than the others, in particular because they move.

According to one embodiment, the casing 60 comprises a lower part which has a geometry such that all of the elements removably connected to the casing 60 are attached to the casing 60 by virtue of an upward vertical movement in the direction of the casing 60.

Moreover, the casing 60 comprises an upper part which has a geometry such that the fuel cells 32 are attached to the casing 60 by virtue of a downward vertical movement in the direction of the casing 60.

According to one embodiment shown in FIG. 3, the grouping device 30 comprises:
fuel cells 32 in which first, second and third fluids flow,
a support 58 comprising a casing 60,
for the first fluid, at least one portion of a first circuit comprising a first feeder configured to supply the fuel cells 32 with first fluid and a first manifold configured to collect the first fluid from the fuel cells 32,
for the second fluid, at least one portion of a second circuit comprising a second feeder configured to supply the fuel cells 32 with second fluid and a second manifold configured to collect the second fluid from the fuel cells 32,
for the third fluid, at least one portion of a third fluid circuit comprising a third feeder configured to supply the fuel cells 32 with third fluid and a third manifold configured to collect the third fluid from the fuel cells 32,
the first, second and third feeders being rigidly secured to the casing 60, at least one of them being positioned inside the casing 60, between the latter and the fuel cells 32, in the housing 78,
the first, second and third manifolds being rigidly secured to the casing 60, at least one of them being positioned inside the casing 60, between the latter and the fuel cells 32, in the housing 78.
Some apparatus of the first, second and/or third fluid circuits being rigidly secured to the casing 60 and partially integrated in the latter.

For each fluid circuit 52, 54, 56, the grouping device 30 comprises an intake and a return.

Whatever the embodiment, a grouping device 30 comprises:
at least two fuel cells 32 in which at least one first fluid flows,
a support 58 comprising a casing 60,
for the first fluid, at least one portion of a first circuit comprising a first feeder configured to supply the fuel cells 32 with first fluid and a first manifold configured to collect the first fluid from the fuel cells 32, the first feeder and the first manifold being rigidly secured to the casing 60 and positioned between the casing 60 and the fuel cells 32.

Such a grouping device 30 may be moved or handled in one piece. It moreover makes it possible to limit the number of points of attachment on the primary structure of the aircraft. Positioning the first feeder and the first manifold between the casing 60 and the fuel cells 32 makes it possible to obtain a more compact assembly.

According to one configuration, the first circuit comprises at least one apparatus partially integrated in the casing 60. This arrangement helps facilitate maintenance, for example.

According to one configuration, the apparatus requiring most frequent maintenance are positioned in the lower part of the casing 60 to make them more accessible and avoid having to dismantle the casing 60 to access them.

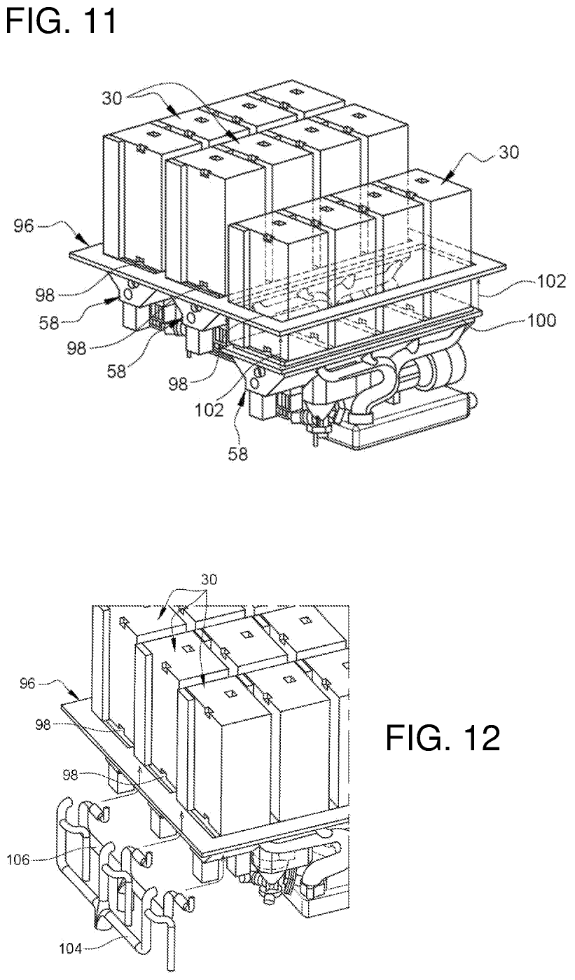

According to one embodiment shown in FIGS. 10 to 13, an aircraft comprises at least one frame 96, connected to the primary structure of the aircraft by connection elements, supporting a plurality of grouping devices 30. In the form illustrated, the frame 96 is in the form of a rectangular flat structural plate comprising one or more openings, which are rectangular in the form illustrated, for the passage of one or more grouping devices. For each grouping device 30, the frame 96 comprises a surround 98 configured to allow insertion of the fuel cells 32 of the grouping device, against which surround the outer shoulder 84 of the casing 60 bears. The shoulder 84 makes it possible to transfer loads from the casing to the frame 96 and therefore the primary structure of the aircraft. According to one configuration, a peripheral seal 100 is inserted between the outer shoulder 84 of the casing 60 and the surround 98 of the frame 96 and each casing 60 is connected to the frame 96 by appropriate connection elements 102, as shown in FIG. 11. This may be for example a bolted connection.

According to one operating mode, each grouping device 30 is assembled to the frame 96 by inserting it from the bottom of the frame 96.

When all of the grouping devices 30 are connected to the frame 96, the intakes of the first fluid circuits 52 are connected up to a main feeder 104 and the returns of the first fluid circuits 52 are connected up to a main manifold 106, as shown in FIGS. 12 and 13.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A grouping device for grouping together fuel cells, comprising at least two fuel cells in which at least a first fluid flows,
wherein the grouping device comprises
a support, and
at least a portion of a first circuit for the first fluid comprising
a first feeder configured to supply the fuel cells with the first fluid, and
a first manifold configured to collect the first fluid from the fuel cells,
the support comprising
a casing,
the first feeder and the first manifold being rigidly secured to the casing and positioned between the casing and the fuel cells.

2. The grouping device according to claim 1, wherein each casing comprises at least one outer shoulder extending over at least part of its periphery.

3. The grouping device according to claim 2, wherein the outer shoulder extends over a whole periphery of the device.

4. The grouping device according to claim 1, wherein the grouping device comprises:
at least a second portion of a second circuit for a second fluid flowing in the fuel cells comprising a second feeder configured to supply the fuel cells with second fluid and a second manifold configured to collect the second fluid from the fuel cells,
at least a third portion of a third circuit for a third fluid flowing in the fuel cells comprising a third feeder configured to supply the fuel cells with the third fluid and a third manifold configured to collect the third fluid from the fuel cells,
the second and third feeders being rigidly secured to the casing, at least one of them being positioned between the casing and the fuel cells, the second and third manifolds being rigidly secured to the casing, at least one of them being positioned between the casing and the fuel cells.

5. The grouping device according to claim 4, wherein the casing comprises at least one opening configured to interact with at least one of the fuel cells, through which opening ducts connected to the fuel cell pass.

6. The grouping device according to claim 5, wherein the casing comprises a bottom, two transverse walls and two longitudinal walls which delimit a housing configured to house at least one feeder out of the first, second and third feeders and at least one manifold out of the first, second and third manifolds.

7. The grouping device according to claim 6, wherein the transverse and longitudinal walls comprise upper edges forming a belt which, in operation, surrounds the fuel cells.

8. The grouping device according to claim 7, wherein the casing comprises at least one inner shoulder offset towards the bottom relative to the upper edges of the transverse and longitudinal walls, said inner shoulder constituting a contact surface for the fuel cells.

9. The grouping device according to claim 1, wherein, for each first, second or third feeder or manifold positioned between the casing and the fuel cells, the casing comprises a first or second through hole configured to house a supply or discharge duct of the feeder or of the manifold or a duct extending the supply or discharge duct of the feeder or of the manifold.

10. The grouping device according to claim 1, wherein, for each first, second or third feeder or manifold positioned on the outside of the casing, the casing comprises a third or fourth through hole for each outlet or inlet duct of the feeder or of the manifold, each third or fourth through hole being configured to house one of the outlet or inlet ducts of the feeder or of the manifold or a duct extending one of the outlet or inlet ducts of the feeder or of the manifold.

11. The grouping device according to claim 1, wherein the grouping device comprises at least one apparatus for at least one fluid circuit comprising first and second parts removably connected by connection elements, at least one of the first and second parts being rigidly secured to and integrated in the casing.

12. The grouping device according to claim 11, wherein another of the first and second parts is a removable part and the removable part is an active part.

13. The grouping device according to claim 12, wherein the apparatus is a valve and the removable part comprises a controller for a flow of fluid between an upstream and a downstream part in the part integrated in the casing.

14. The grouping device according to claim 12, wherein the apparatus is a system for extracting water and the active part comprises a valve for purging the water created by the extraction system.

15. An aircraft comprising a primary structure and at least one fuel cell grouping device according to claim 1.

16. The aircraft according to claim 15, wherein the aircraft comprises at least one frame connected to the primary structure of the aircraft for each grouping device, the frame comprising a surround configured to allow insertion of the fuel cells of the grouping device, against which surround the casing bears.

17. The aircraft according to claim 16, wherein each casing comprises at least one outer shoulder extending over at least part of its periphery and configured to bear against one of the surrounds of the frame to transfer loads from the casing to the primary structure.

18. The aircraft according to claim 17, wherein a peripheral seal is inserted between the outer shoulder of the casing and the surround of the frame.
